(19) United States
(12) Patent Application Publication
(10) Pub. No.: US 2006/0167648 A1
(43) Pub. Date: Jul. 27, 2006

(54) 3-Dimensional measurement device and electronic storage medium

(76) Inventor: Hitoshi Ohtani, Tokyo (JP)

Correspondence Address: BAKER & BOTTS, 30 ROCKEFELLER PLAZA, 44TH FLOOR, NEW YORK, NY, 10112, US

(21) Appl. No.: 10/531,230

(22) PCT Filed: Aug. 12, 2004
(86) PCT No.: PCT/JP04/11862

§ 371 Date: Jan. 26, 2006

(30) Foreign Application Priority Data
Aug. 13, 2003 (JP) 2003-207528

(51) Int. Cl. G01C 17/00

(52) U.S. Cl. 702/150

(57) ABSTRACT

The present invention is a three-dimensional survey system (or the like) for computing three-dimensional coordinate data with a survey apparatus and image acquisition devices; the survey apparatus being adapted to measure the position of a collimation target from distance and angle, the image acquisition devices each acquiring images of the object to be measured, inclusive of an image of the collimation target, from different multiple directions, and an arithmetic processing element being able to match, by using the collimation target as a tie point, the images that have been acquired by the image acquisition devices, relate the collimation target position that has been measured by the survey apparatus, and the collimation target in each of the matched images, and compute three-dimensional coordinate data of the object to be measured, in accordance with the related target data.

### TECHNICAL FIELD

The present invention relates to three-dimensional survey systems (and like systems) for computing three-dimensional coordinate data using a survey apparatus and image acquisition devices, and more particularly, to a three-dimensional survey system capable of making stereographic displays by determining positions of tie points using a survey apparatus.

### BACKGROUND ART

In conventional methods, image acquisition means (for example, digital cameras) and a reference structure of known dimensions are used to obtain three-dimensional coordinates from image data. The reference structure is rested near the object to be selected as a measurement target, and images of this reference structure are acquired from two or more directions with the cameras. These cameras have an inclinometer for measuring longitudinal/lateral inclinations of images. The reference structure is of known dimensions, and for example, a triangular structure is used as the reference structure. Previously surveyed positions are selected as camera-photographing positions and a position at which the reference structure is to be rested.

Photographing from the above photographing positions is conducted in the composition where an image of the object selected as the measurement target, and an image of the reference structure will be formed at the same time. The relationship between the reference structure, the photographing position, and the position on the acquired image, is derived by absolute orientation, and three-dimensional coordinates of the object as the measurement target, are calculated.

However, a reference structure of known dimensions, or the like, must be installed beforehand to conduct the above absolute orientation in the conventional methods. Also, the installation position for the reference structure and the camera-photographing positions must be surveyed. There have been the problems that it is very troublesome to perform surveys as well as to place the reference structure and install the cameras, and that if the structure is a building, it is usually very large and requires much more troublesome operations. Additionally, there have been the problems that before a photographing altitude can be measured, an inclinometer for detecting inclinations must be provided on the camera, and that a special camera that permits this is extremely expensive.

### DISCLOSURE OF INVENTION

The present invention was made with the above problems in view, and the invention has a survey apparatus for measuring a position of a collimation target from distance and angle data, and image acquisition devices each for acquiring images of an object to be measured, inclusive of an image of the collimation target, from different plural directions. The present invention further includes: arithmetic processing means that matches, by using the collimation target as a tie point, the images that have been acquired by the image acquisition devices, relates the collimation target position that has been measured by the survey apparatus, and the collimation target in each of the matched images, and computes three-dimensional coordinate data of the object to be measured, in accordance with above-related data.

The present invention can also be constructed so that: the survey apparatus placed at a known point measures positions of at least six collimation targets, and the arithmetic processing means conducts corrections for inclinations or rotational angle errors of the image acquisition devices, calculates positions of the image acquisition devices from the position of the collimation target and the images acquired from the image acquisition devices, and computes three-dimensional coordinate data of the object to be measured, the coordinate data having been acquired by the image acquisition devices.

Additionally, the collimation target(s) in the present invention can be formed of a retroreflective material and constructed so that a mark that facilitates collimation is formed on the surface of the material.

Furthermore, the present invention can be a three-dimensional survey apparatus in which the mark is constituted by a marker section identifiable from image data of image acquisition devices, and by a symbol that an operator can identify.

Moreover, the mark in the present invention can also be constituted by the cross hairs that facilitate collimation, a visually identifiable character, and an electrically readable code.

The visually identifiable character can be made into a numeric one, and the electrically readable code into a bar code squill.

Furthermore, a three-dimensional survey method according to the present invention includes: a first process step of measuring a position of a collimation target from distance data and angle data by means of a survey apparatus; a second process step of acquiring images of an object, inclusive of an image of the collimation target, from different directions by using a plurality of image acquisition devices; a third process step of matching, by using the collimation target as a tie point, the images acquired by the image acquisition devices; a fourth process step of relating the collimation target position measured by the survey apparatus in the first process step, and the collimation target in each of the matched images; and a fifth process step of computing three-dimensional coordinate data on the object to be measured, in accordance with the data related in the fourth process step.

Furthermore, a three-dimensional survey system according to the present invention includes: a survey apparatus for measuring a position of a collimation target from distance and angle data and acquiring images of an object, inclusive of an image of the collimation target; image acquisition devices each for acquiring imaged of an object to be measured, inclusive of an image of the collimation target, from different plural directions; and arithmetic processing means that matches the images that have been acquired by the survey apparatus, and the images that have been acquired by the image acquisition devices, further matches, by using the collimation target as a tie point, the images acquired by the image acquisition devices, relates the collimation target position that has been measured by the survey apparatus, and the collimation target in each of the matched images, and computes three-dimensional coordinate data of the object to be measured, in accordance with above-related data.

Furthermore, an electronic storage medium according to the present invention is constructed to have a program stored inside to lay down procedural steps of: reading both distance data and angle data on the collimation target measured by a survey apparatus; reading image data inclusive of the collimation target photographed from different directions by a plurality of image acquisition devices; matching the images acquired by the survey apparatus, and the images acquired by the image acquisition devices; further matching, by use of the collimation target as a tie point, the images acquired by the image acquisition devices; relating the collimation target position measured by the survey apparatus, and the collimation target in each of the matched images; and computing three-dimensional coordinate data of the object to be measured, in accordance with above-related target data.

### BRIEF DESCRIPTION OF DRAWINGS

FIG. 1 is a diagram explaining a first embodiment of the present invention.

FIG. 2 is another diagram explaining the first embodiment of the present invention.

FIG. 3 is a diagram explaining a target mark 2000 in the first embodiment.

FIG. 4 is a diagram explaining a survey machine 1000 in the first embodiment.

FIG. 5 is a diagram explaining a configuration of the survey machine 1000 in the first embodiment.

FIG. 6 is a diagram explaining a second embodiment of the present invention.

FIG. 7 is another diagram explaining the second embodiment of the present invention.

FIG. 8 is a diagram explaining a configuration of the survey machine 1000 used in the second embodiment.

FIG. 9 is a diagram that explains operation of the second embodiment.

### BEST MODE FOR CARRYING OUT THE INVENTION

### EMBODIMENTS

Embodiments of the present invention are described hereunder in accordance with the accompanying drawings.

### First Embodiment

A first embodiment is a three-dimensional survey system that uses target marks 2000 as pass points.

A total station that can measure distances up to reflection prisms placed at land survey points is used as a survey machine 1000. Also, the target marks 2000 are used that are drawn on a reflection sheet so that the marks can be used as pass points of stereographic images and instead of reflection prisms.

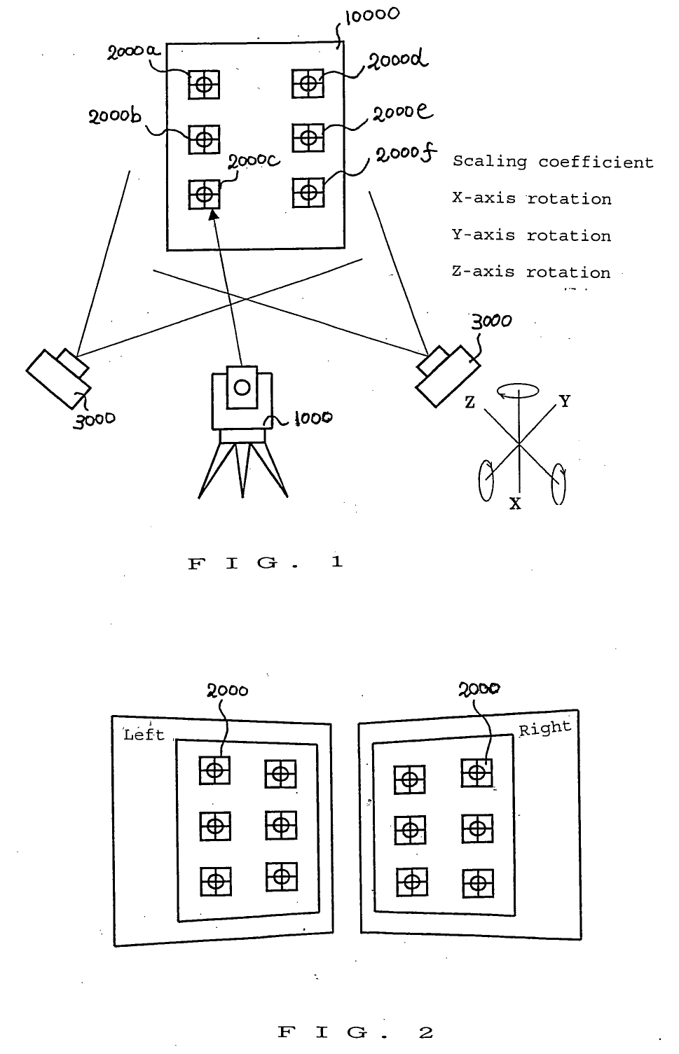

The first embodiment is described below using FIG. 1.

A target mark 2000a, 2000b, 2000c, 2000d, 2000e, or 2000f is rested in or attached (using an adhesive or the like) to at least six positions on an object to be measured (hereinafter, referred to as the measurement target 10000). The six positions are taken as pass points of the measurement target 10000.

For stereographing from any two lateral positions, cameras are rotated longitudinally and laterally from respective centers of the cameras, i.e., in directions of three optical axes (X-axis, Y-axis, and Z-axis). The resulting inclinations of the cameras are expressed as (ω, φ, κ: roll, pitch, and yaw, respectively).

To solve these parameters as variables, six pass points that are mathematically known are required.

Next, a survey machine 1000 is installed at a known point distant from the measurement target 10000, the known point being a position at which the target marks 2000 are to be measured. The known point in this case is a point derived by use of a GPS-equipped device, survey datum points, and/or the like, and having a coordinate position inclusive of height.

A tripod is placed on the known point, then the survey machine 1000 is installed on the tripod, and machine height is measured. The machine height is an actual height for surveying.

A second known point is collimated with the survey machine 1000, and this point is taken as a datum point for measuring a horizontal angle. After the collimation, the target marks 2000a to 2000f are collimated and then surveyed to obtain horizontal angles, altitude angles, and distances between the target marks.

Coordinate positions of the target marks 2000a to 2000f are determined by the distance from the known point at which the survey machine 1000 is installed, to the second known point, distances from the known point to each of the target marks 2000a to 2000f, and the respective horizontal angles and altitude angles from the datum point.

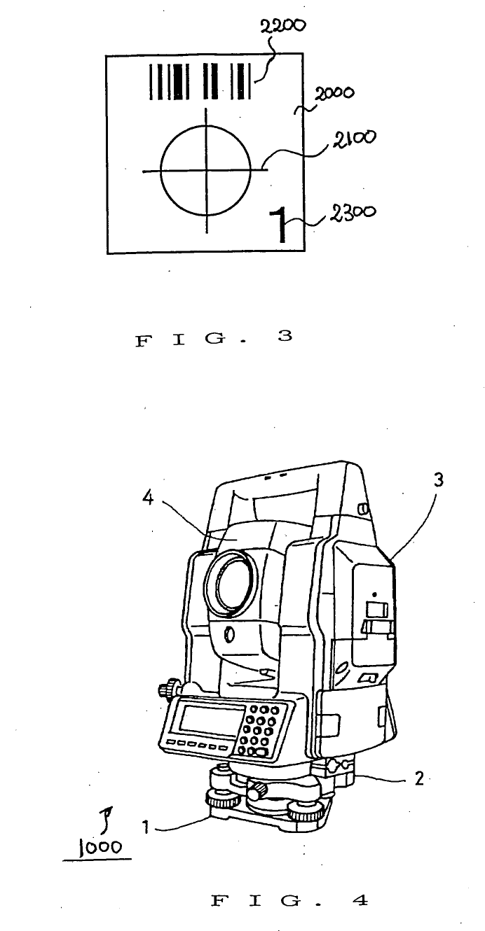

Next, as shown in FIG. 2, the target marks 2000a to 2000f, together with the measurement target 10000, are photographed from at least two directions (left/right) using digital cameras 3000.

Relative orientation for deriving a relationship in relative position between the digital cameras 3000 that have acquired images from the left/right directions is conducted with the target marks 2000a to 2000f as pass points.

During the relative orientation, the relationship in relative position between the digital cameras 3000 that have acquired the left/right images can be derived by specifying tie points (pass points) of the left/right images. This makes it possible to define a three-dimensional coordinate system with an optical axis of the left camera as its center, and hence to define a three-dimensional coordinate system with an optical axis of one digital camera 3000 as its center.

The coordinate positions of the pass points that were obtained during surveying with the survey machine 1000 are assigned to the model coordinate system that was obtained from the relative orientation, and then this model coordinate system is transformed into a terrestrial coordinate system by conducting absolute orientation.

The absolute orientation here is an operation of transforming the model coordinate system that was obtained from the relative orientation, into a terrestrial coordinate system. The transformation can be conducted by assigning terrestrially measured three-dimensional coordinate data to the points on the images.

The photographs that were obtained using the digital cameras 3000 are central projection photographs whose centers and peripheries differ in scaling coefficient. After absolute orientation, the resulting images are transformed into ortho-images that are parallel projected images.

The ortho-images are described here. Whereas the camera-obtained photographs are central projection photographs, the central projection photographs further generated by oblique orthogonal projection are called orthophotos. Each of the central projection photographs was obtained through a lens. Unlike a scale of a map, therefore, that of the entire photograph is not uniform. The orthophotos, however, are uniform in scale since they were generated by oblique orthogonal projection, and can therefore be handled similarly to maps.

The images acquired by the digital cameras 3000 are constructed from data of small pixel units, and coordinates are assigned to each of the pixels by relative orientation and absolute orientation. Two-dimensional displays on a display apparatus or the like are shaded according to three-dimensional coordinates. During coordinate conversion, coordinates in pixel units are newly calculated and then displayed in the form of operation such as rotation.

As described above, the present first embodiment relates to a three-dimensional survey system capable of making stereographic displays by computing three-dimensional coordinate data with the survey machine 1000 and the digital cameras 3000.

One example of a relationship between data measured by the survey machine 1000, and an image acquired by one digital camera 3000, is described below.

$$x = - f \frac{ {a}_{11} ( X - Xc ) + {a}_{12} ( Y - Yc ) + {a}_{13} ( Z - Zc )}{{a}_{31} ( X - Xc ) + {a}_{32} ( Y - Yc ) + {a}_{33} ( Z - Zc )} \\ y = - f \frac{ {a}_{21} ( X - Xc ) + {a}_{22} ( Y - Yc ) + {a}_{23} ( Z - Zc )}{{a}_{31} ( X - Xc ) + {a}_{32} ( Y - Yc ) + {a}_{33} ( Z - Zc )} \qquad ( Formula 1 )$$

where “f” is a focal distance of the digital camera 3000, “a” is (ω, φ, κ: roll, pitch, and yaw, respectively) that denotes an inclination (rotational angles of three axes) of the digital camera 3000, “(X, Y, Z)” is three-dimensional data measured by the survey machine 1000, and “(Xc, Yc, Zc)” denotes position coordinates of the digital camera 3000 with respect to the survey machine 1000.

FIG. 3 is an enlarged view of the target mark 2000. A base thereof is constructed of a retroreflective sheet. The cross hairs 2100 denoting a collimation point, and a circle with the cross hairs in its center, also for facilitating collimation, are drawn on the sheet. Above the circle is drawn a bar code 2200 to make this code easily readable when the target mark is transformed into an image. A numeric character 2300 for a measuring person to identify the target mark 2000 is drawn below the circle.

An adhesive is attached to the reverse of the target mark 2000 so that the mark itself can be attached to any object to be measured. A method of installing the target mark can be combined with a method other than adhesive usage. For example, the target mark can be attached to a magnet on the sheet.

The target mark 2000 is associated with a collimation target, and the circle with the cross hairs 2100 in its center is equivalent to a mark that facilitates collimation.

The bar code 2200 is equivalent to a marker section identifiable from image data of the image acquisition device, and the numeric character 2300 corresponds to a symbol that an operator can identify. The bar code 2200 is further equivalent to an electrically readable code.

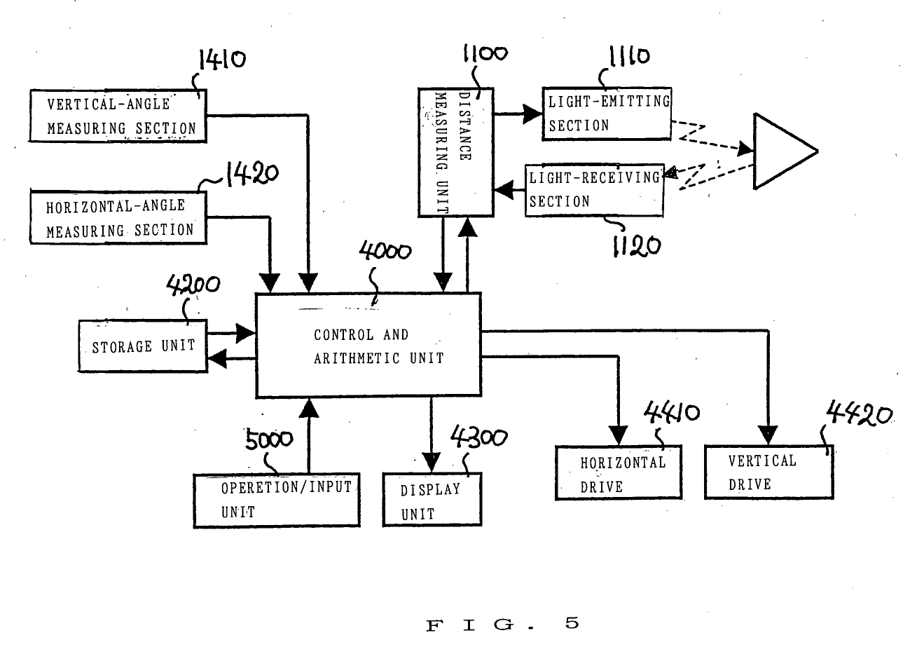

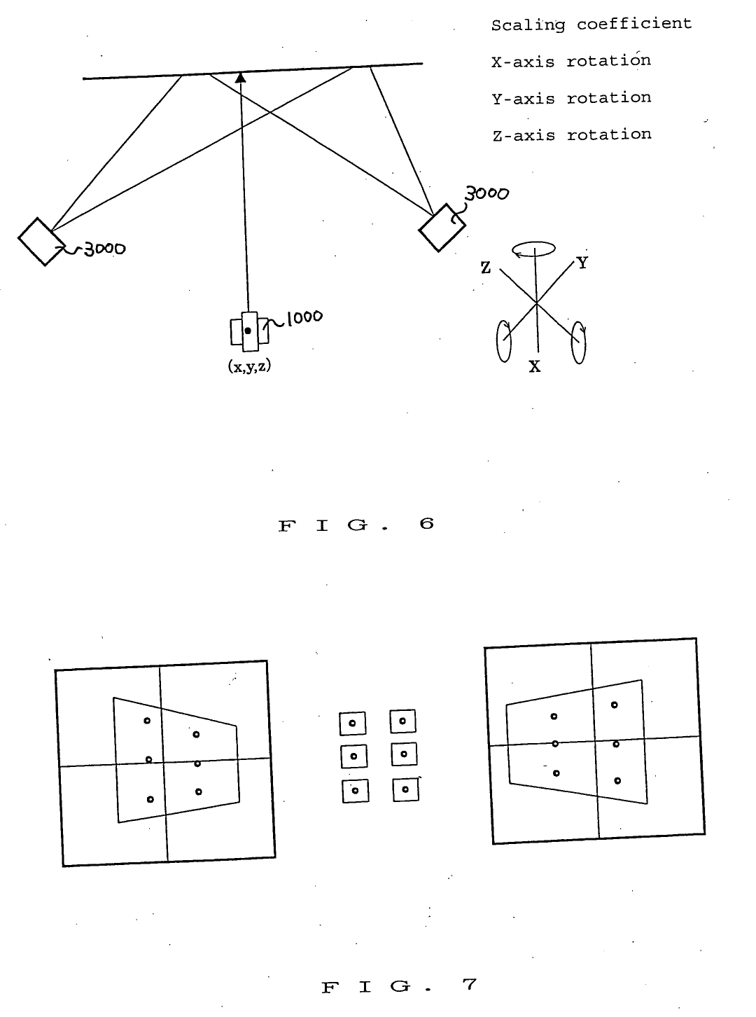

As shown in FIGS. 4 and 5, the survey machine 1000 is a total station, containing an electronic theodolite for vertical and horizontal angle detection, and an electro-optical range finder.

In the present embodiment, the survey machine 1000 and the digital cameras 3000 are constructed as independent bodies.

Next, an electrical configuration of the survey machine 1000 in the present embodiment is described below in accordance with FIG. 5.

The survey machine 1000 includes a distance-measuring unit 1100, an angle-measuring unit 1400, a storage unit 4200, a display unit 4300, a driving unit 4400, a control and arithmetic unit 4000, and an operations/input unit 5000. The storage unit 4200 is for storing data, programs, and the like. Using the display unit 4300 and the operations/input unit 5000 allows a user to operate the survey machine 1000.

An electro-optical range finder is used as the distance-measuring unit 1100. The distance-measuring unit 1100 measures a distance to a distance-measurement target from a phase difference, arrival time difference, and other factors of reflected light. The distance-measuring unit 1100 has a light-emitting section 1110 and a light-receiving section 1120, and distance-measuring light from the light-emitting section 1110 is emitted in a direction of an object to be measured. The distance-measuring unit 1100 is constructed so that the light reflected from the object to be measured will enter the light-receiving section 1120, whereby the distance to the object to be measured is measurable.

More specifically, the distance from the survey machine 1000 to the object to be measured is calculated from a differential time from emission of pulse light from the light-emitting section 1110, to reception of the light by the light-receiving section 1120. The calculation is conducted within the control and arithmetic unit 4000.

The angle-measuring unit 1400 is for calculating a horizontal angle and a vertical angle, and includes a vertical-angle measuring section 1410 and a horizontal-angle measuring section 1420.

The vertical-angle measuring section 1410 can use a vertical-angle encoder, for example, to detect the quantity of vertical rotation from a horizontal or zenith direction. The horizontal-angle measuring section 1420 can use a horizontal-angle encoder, for example, to detect the quantity of horizontal rotation from a reference direction. These encoders are both constituted by, for example, a rotor installed at a pivotal section, and a stator formed at a fixed section.

The angle-measuring unit 1400 that includes the vertical-angle measuring section 1410 and the horizontal-angle measuring section 1420 is adapted to calculate horizontal and vertical angles from detected quantities of horizontal rotation and of vertical rotation.

The driving unit 4400 includes a horizontal drive 4410 and a vertical drive 4420, and can rotate the survey machine 1000 in both horizontal and vertical directions via respective motors.

The control and arithmetic unit 4000 includes a CPU and others, and performs various arithmetic operations.

A program in which is prestored a computing procedure that an arithmetic section 1300 of the survey machine 1000 is to use can be stored onto an electronic storage medium such as an FD, CD, DVD, RAM, ROM, or memory card.

The survey machine 1000, as shown in FIG. 4, includes a telescope 4, a mounting frame 3 that supports the telescope 4 in such a form as to enable its vertical rotation, and a base 2 that supports the mounting frame 3 in such a form as to enable its horizontal rotation. The base 2 is installable on a tripod or the like, via a leveling base 1.

The survey machine 1000 has an operations panel formed as part of the operations/input unit 5000, and a display forming part of the display unit 4300. Furthermore, the telescope 4 has an exposed objective lens.

### Second Embodiment

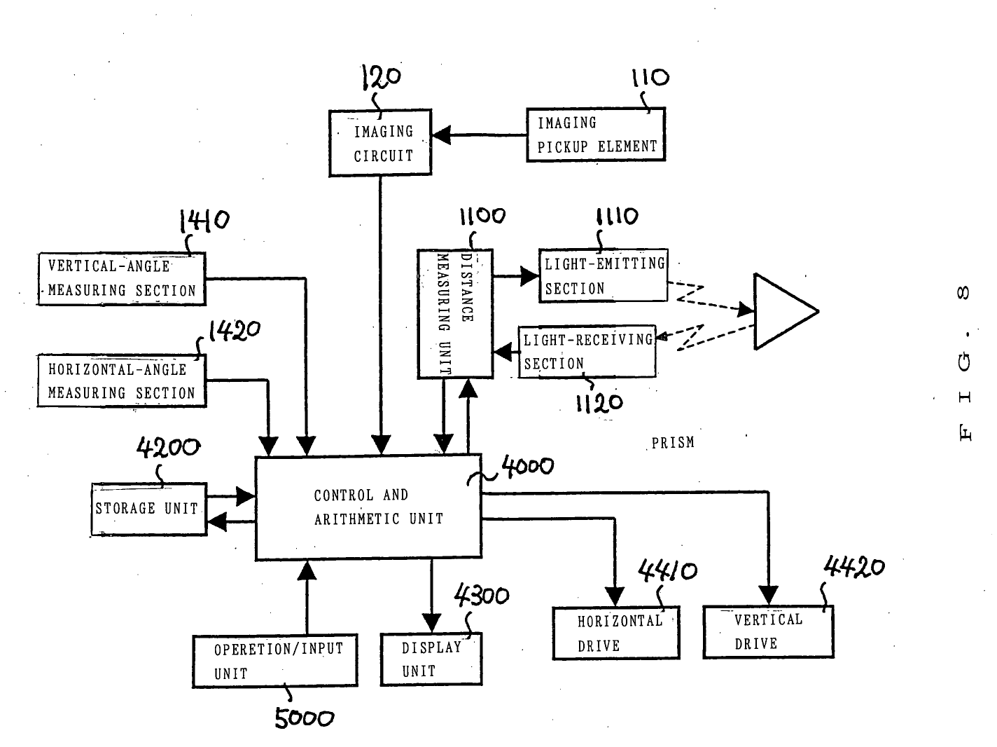

A second embodiment not using target marks 2000 as pass points, is described per FIGS. 6 and 7. The second embodiment, unlike the first embodiment, has an image acquisition device 100 in a survey machine 1000.

The survey machine 1000 can use the image acquisition-device 100 to acquire images of an object present in a collimating direction. A non-prism function that captures direct reflections from natural objects and does not require a reflection prism is used as a distance-measuring function of the survey machine 1000.

As shown in FIGS. 6 and 7, the survey machine 1000 collimates any section of an object to be measured, measures a distance to that section, and similarly measures a horizontal angle and a vertical angle. The image acquisition device 100 then acquires an image of a location to be surveyed. Since a collimation point is the center of an optical axis, the collimation point agrees with the center of the image. Survey values and images of at least six positions are acquired since the location to be surveyed forms a pass point.

After the surveys, images are acquired from at least two directions using digital cameras 3000, as in the first embodiment.

Next, acquired images are matched between the digital cameras 3000 and the survey machine 1000. The images are matched by conducting corrections in terms of scaling coefficient, grayscale level, and rotational angle, and associated collimation positions are determined as pass points of the camera images.

The determination of the pass points is followed by relative orientation for deriving a relationship in relative position between the digital cameras 3000 that acquired the images from the respective (left/right) directions. As in the first embodiment, coordinate positions of the pass points which were obtained during surveying with the survey machine 1000 are added and after absolute orientation, the resulting images are transformed into ortho-images.

The image acquisition device 100 used to transform imaging device data into digital data. The image acquisition device 100 is for example, a solid-state image pickup device such as a CCD. The image acquisition device 100 includes an image pickup element 110 constructed by a CCD and/or other elements. and an imaging circuit 120 that forms image signals from output signals of the image pickup element 110.

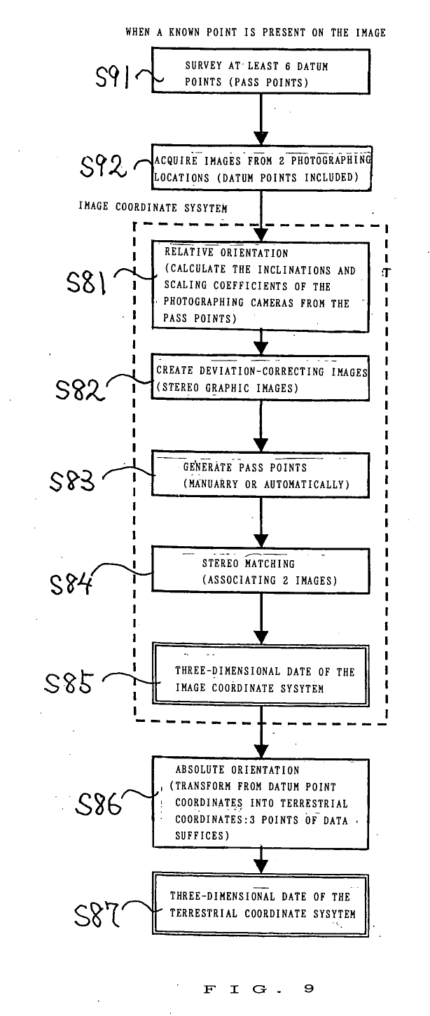

Next, an electrical configuration of the survey machine 1000 in the present embodiment is described below in accordance with FIG. 8.

The survey machine 1000 includes an image acquisition device 100, a distance-measuring unit 1100, an angle-measuring unit 1400, a storage unit 4200, a display unit 4300, a driving unit 4400, a control and arithmetic unit 4000, and an operations/input unit 5000. The storage unit 4200 is for storing data, programs, and the like. Using the display unit 4300 and the operations/input unit 5000 allows a user to operate the survey machine 1000.

The electrical configuration is essentially the same as that of the first embodiment, except that the image acquisition device 100 is included. Further detailed description of the electrical configuration is therefore omitted.

Next, operation of the second embodiment is described hereunder in accordance with FIG. 9.

First, in step S91, a target mark 2000a, 2000b, 2000c, 2000d, 2000e, or 2000f is rested in at least six positions on an object to be measured (hereinafter, referred to as the measurement target 10000). The six positions are taken as pass points. After being rested, the target marks are surveyed.

In following step S92, the target marks 2000a to 2000f, together with the measurement target 10000, are photographed from at least two directions (left/right) using digital cameras 3000.

In next step S81, relative orientation is conducted using the collimation points (pass points) that were obtained in step S91. In S81, relationships between inclinations, scaling coefficients, and other parameters of the stereographic images acquired by the digital cameras 3000 can be calculated from the pass points.

Next, in step S82, deviation-correcting images are created to associate the pass points of the stereographic images. A projective transformation is conducted to create the deviation-correcting images in step S82. The projective transformation refers to such a transformation in which photograph coordinates at a point on a light-receiving element of one digital camera 3000 are projected onto other planes. In this case, feature points are extracted from one image and then the other image is scanned for tie points on the same horizontal line.

There is a need, therefore, to translate the digital cameras 3000 in a horizontal direction and transform images into the resulting images. That is to say, the images used need to be transformed into the images appearing as if they had been acquired by translating the digital cameras 3000. Such transformation makes it possible to search for tie points even in the images obtained by moving naturally the digital cameras 3000. Furthermore, pass points are generated manually or automatically in step S83.

In step S84, stereo matching is conducted. Stereo matching is a method for automatically searching for tie points in the two acquired images.

In next step S85, the relationship in relative position between the digital cameras 3000 that acquired the images from the respective (left/right) directions can be derived using the tie points that were searched for in step S84. The above, in turn, makes it possible to define a three-dimensional coordinate system with an optical axis of the left camera as its center, and hence to define a three-dimensional coordinate system with an optical axis of one digital camera 3000 as its center.

Next, in step S86, the coordinate positions of the pass points that were obtained during surveying with the survey machine 1000 are assigned to the model coordinate system that was obtained from the relative orientation, and then this model coordinate system is transformed into a terrestrial coordinate system by conducting absolute orientation.

The absolute orientation here is an operation of transforming the model coordinate system that was obtained from the relative orientation, into a terrestrial coordinate system. The transformation can be conducted by assigning terrestrially measured three-dimensional coordinate data to the points on the images.

In next step S87, data is transformed into three-dimensional data of the terrestrial coordinate system. The three-dimensional data can be used, for example, to display ortho-images that are to be expanded into terrestrial image form.

The ortho-images are described here. Whereas the camera-obtained photographs are central projection photographs, the central projection photographs further generated by oblique orthogonal projection are called orthophotos. Each of the central projection photographs was obtained through a lens. Unlike a scale of a map, therefore, that of the entire photograph is not uniform. The orthophotos, however, are uniform in scale since they were generated by oblique orthogonal projection, and can therefore be handled similarly to maps.

The images acquired by the digital cameras 3000 are constructed from data of small pixel units, and coordinates are assigned to each of the pixels by relative orientation and absolute orientation. Two-dimensional displays on a display apparatus or the like are shaded according to three-dimensional coordinates. During coordinate conversion, coordinates in pixel units are newly calculated and then displayed in the form of operation such as rotation.

As described above, the present embodiment relates to a three-dimensional survey system capable of making stereographic displays by computing three-dimensional coordinate data with the survey machine 1000 and the digital cameras 3000.

The present invention thus constructed has: a survey apparatus for measuring a position of a collimation target from distance and angle data; image acquisition devices each for acquiring images of an object to be measured, inclusive of an image of the collimation target, from different plural directions; and arithmetic processing means that matches, by using the collimation target as a tie point, the images that have been acquired by the image acquisition devices, relates the collimation target position that has been measured by the survey apparatus, and the collimation target in each of the matched images, and computes three-dimensional coordinate data of the object to be measured, in accordance with above-related data.

The present invention is therefore effective in that it can obtain three-dimensional coordinate data conveniently and accurately.

### INDUSTRIAL APPLICABILITY

The present invention relates to three-dimensional survey systems (and like systems) for computing three-dimensional coordinate data using a survey apparatus and image acquisition devices, and more particularly, to a three-dimensional survey system capable of making stereographic displays by determining positions of tie points using a survey apparatus.

1. A three-dimensional survey system, comprising:
a survey apparatus for measuring a position of a collimation target from distance and angle;
an image acquisition devices each for acquiring images of an object to be measured, inclusive of an image of the collimation target, from different plural directions; and
arithmetic processing means that matches, by using the collimation target as a tie point, the images that have been acquired by said image acquisition devices, relates the collimation target position that has been measured by said survey apparatus, and the collimation target in each of the matched images, and computes three-dimensional coordinate data of the object to be measured, in accordance with the related target data.

2. The three-dimensional survey system according to claim 1, wherein:
said survey apparatus placed at a known point measures positions of at least six collimation targets; and
said arithmetic processing means performs corrections for inclinations or rotational angle errors of said image acquisition devices, calculates positions thereof from not only the position of the collimation target, but also the images acquired from said image acquisition devices, and computes three-dimensional coordinate data of the object to be measured, the coordinate data having been acquired by said image acquisition devices.

3. The three-dimensional survey system according to claim 1, wherein:
each of the collimation targets is formed of a retroreflective material, and on the surface thereof is formed a mark that facilitates collimation.

4. The three-dimensional survey system according to claim 3, wherein:
said mark includes a marker section identifiable from image data of said image acquisition devices, and a symbol that an operator can identify.

5. The three-dimensional survey system according to claim 3, wherein:
said mark includes the cross hairs that facilitate collimation, a visually identifiable character, and an electrically readable code.

6. The three-dimensional survey system according to claim 5, wherein;
said visually identifiable character is a numeral and the electrically readable code is a bar code.

7. A three-dimensional survey method, comprising:
a first step of measuring a position of a collimation target from distance data and angle data by means of a survey apparatus;
a second step of acquiring images, inclusive of an image of the collimation target, from different directions by using a plurality of image acquisition devices;
a third step of matching, by using the collimation target as a tie point, the images acquired by the image acquisition devices;
a fourth step of relating the collimation target position measured by the survey apparatus in said first step, and the collimation target in each of the matched images; and
a fifth step of computing three-dimensional coordinate data on the object to be measured, in accordance with the data related in said fourth step.

8. A three-dimensional survey system, comprising:
a survey apparatus for measuring a position of a collimation target from distance and angle and acquiring images inclusive of an image of the collimation target;
an image acquisition devices each for acquiring images of an object to be measured, inclusive of an image of the collimation target, from different plural directions; and
arithmetic processing means that matches the images that have been acquired by said survey apparatus, and the images that have been acquired by said image acquisition devices, further matches, by using the collimation target as a tie point, the images acquired by said image acquisition devices, relates the collimation target position that has been measured by said survey apparatus, and the collimation target in each of the matched images, and computes three-dimensional coordinate data of the object to be measured, in accordance with the related target data.

9. An electronic storage medium formed as an FD, CD, DVD, RAM, ROM, memory card, or the like, said storage medium having a program stored therein to lay down procedural steps of:
reading both distance data and angle data of the collimation target measured by a survey apparatus;
reading image data inclusive of the collimation target photographed from different directions by a plurality of image acquisition devices;
matching the images acquired by the survey apparatus, and the images acquired by the image acquisition devices;
further matching, by use of the collimation target as a tie point, the images acquired by the image acquisition devices;
relating the collimation target position measured by the survey apparatus, and the collimation target in each of the matched images; and
computing three-dimensional coordinate data of the object to be measured, in accordance with the related target data.
